(19) United States
(12) Patent Application Publication
(10) Pub. No.: US 2010/0219165 A1
(43) Pub. Date: Sep. 2, 2010

(54) METHOD OF AND DEVICE FOR BUTT WELDING WITHOUT WELD FILLER MATERIALS THIN METAL SHEETS USING CLAMPING PRESSING DEVICES, AT LEAST ONE PRESSING ELEMENT BEING SUITABLE FOR APPLYING TWO OR MORE DISTINCT PRESSURE LEVELS

(76) Inventors: Peter Woltering, Neuenkirchen (DE); Karl-Heinz Dulle, Olfen (DE); Randolf Kieffer, Gelsenkirchen (DE); Stefan Oelmann, Hemer (DE); Ulf-Steffen Bäumer, Dortmund (DE); Joachim Hoedtke, Kiel (DE); Günther Kobabe, Hamburg (DE)

Correspondence Address: Charles Muserlain, 317 Bliss Lane, Valley Cottage, NY, 10989, US

(21) Appl. No.: 12/308,737

(22) PCT Filed: Jun. 23, 2007
(86) PCT No.: PCT/EP2007/056279

§ 371 Date: Jun. 11, 2009

(30) Foreign Application Priority Data
Jun. 23, 2006 (DE) 10 2006 029292.8

(51) Int. Cl. B23K 11/02

(52) U.S. Cl. 219/104; 219/101

(57) ABSTRACT

A device for the linear butt welding of thin metal sheets without weld filler materials comprising movable welding heads, a clamping device having at least two pressing elements which operate independently of one another at least one of the pressing elements being suitable for applying two or more distinct pressure levels and additional horizontal pressing elements are further provided in order to press the metal sheets to be welded against one other while being deformed, until full-area contact of the metal-sheet edges butting against one another is achieved as well as a welding method making use of the device.

The invention is directed to a device for the linear butt welding of thin metal sheets without weld filler materials, provided with a carrier table and at least one clamping device arranged above and parallel to the carrier-table surface, under which one or more metal sheets can be positioned. The clamping device is capable of exerting a pressure in the vertical direction on metal sheets introduced thereunder. The welding device according to the invention further comprises one or more movable welding heads, whereas the clamping device presents at least two pressing elements operating independently of one another, arranged in parallel and spaced-apart along the welding line and movable independently of one another, at least one of the pressing elements being suitable for applying two or more pressure levels, additional horizontal pressing elements being provided at least on the side of the carrier table wherein the pressing element suitable for applying multiple pressure levels is present, by means of which at least one of the metal sheets to be welded can be pressed in the direction of the welding line and against the other metal sheet simultaneously undergoing a deformation until a full-area contact of the metal-sheet edges butting against one another is achieved. The welding head is arranged such that it can be moved along the welding line, while a purging-gas duct runs below the carrier table and parallel to the welding line. Under another aspect, the invention is directed to a welding method making use of the welding device.

Welding methods without weld filler materials are disclosed in the prior art, wherein the adjoining semi-finished products are leak-proof connected to one another by means of the fusion of the abutting edges and subsequent consolidation, without any elaborate edge preparation. Since no weld filler material is used, not even one consisting of the same material as the semi-finished products, it is critical that the surfaces abutting against each other have a gapless contact. The result of voids or gaps would be that the fused material would not form any root in this region and hence flow out with no edge formation taking place. Customary methods are laser-welding or electron beam-welding. In the present specification, the term “welding method” hereafter shall be understood as referring only to methods making use of no weld filler material.

Several problems are associated with the welding of thin metal sheets, so that assembling larger metal sheets by welding a plurality of small metal sheets is normally avoided. The major problem consists of introducing an amount of heat too large to be dissipated quickly enough by the surrounding material. This leads to local distortions along the weld joint or even to deformations of the whole metal sheet. In case there are no raw metal sheets available in an appropriate size as one-piece material, they have to be assembled out of individual pieces to form the so-called tailored blanks. These individual metal sheets are normally cut off from continuous sheets of metal by means of a shearing cut. The cutting method by means of punching shears or the like gives rise, depending on the length of cut, to a cut edge horizontally arched by about 0.2 to 0.4 mm as described in DE 42 35 110 C1. A contraction of this kind is also to be observed on the longitudinal edges of rolled steel strips. As a rule therefore, before welding, it is necessary to pretreat the cut edge by means of a grinding or milling method if a very high-quality welded joint is to be produced.

In DE 42 35 110 C1, it is proposed to treat again these curved cut or outer edges of the raw metal sheet by means of a suitable cutting tool in order to ensure the required straightness at the edge. In DE 196 24 776 C1 it is disclosed that, in the case of linear joints, the required linearity is achieved by either cutting the metal sheets by means of precision shears, or by simultaneously trimming both of the metal-sheet edges to be welded by means of double-cut shears.

DE 39 09 620 A1 discloses a device and a method for the butt welding of mechanically cut metal-sheet edges. In this case, it is proposed to press the plates to be welded against one another and to close the possible residual gap by levelling off the existing burr into the gap. In this case, the presence of a considerable amount of burr is necessary, which should actually be avoided in a severing process. Furthermore, a burr is relatively indeterminate in terms of size and is therefore suitable only to a limited extent for a uniform gap closure.

The methods disclosed in the prior art require a complicated pretreatment step in order to allow a gapless joint closure. It is one aspect of the present invention to provide a welding device and a welding method overcoming the limitations of the prior art.

In DE 42 35 110 C1, it is disclosed that non-straight strip edges forced against one another into the welding position become wavy, that is raised and lowered in the vertical direction. However, it was surprisingly observed that these vertical distortions can be prevented if the raw metal sheets are tension-mounted along the welding edge and the two welding edges are pressed against one another before welding so as to level off the material unevenness and to restore linearity in the welding edge planes.

The object of the invention is achieved by means of a device for linear butt welding of thin metal sheets without weld filler materials, provided with a carrier table and one or more clamping devices arranged above and parallel to the carrier-table surface, under which one or more metal sheets can be positioned. The clamping device is capable of exerting a pressure in the vertical direction on metal sheets introduced thereunder. The welding device further comprises one or more movable welding heads, the clamping device being provided with:
at least two pressing elements operating independently of one another, arranged in parallel and spaced-apart along the welding line and movable independently of one another, wherein at least one of the pressing elements is suitable for applying two or more distinct pressure levels,
additional horizontal pressing elements at least on the side of the carrier table wherein the pressing element suitable for applying multiple distinct pressure levels is present, by means of which at least one of the metal sheets to be welded can be pressed in the direction of the welding line and against the other metal sheet while undergoing a deformation,
means for moving the welding head along the welding line,
a purging-gas duct running below the carrier table and parallel to the welding line.

The force to be applied by the horizontal pressing elements is so high that the opposite butting edges of the two metal sheets are ideally pushed towards one another into full-area contact. Voids or gaps possibly present, which result from unevenness or surface roughness of the butting edges, are in this case leveled off. The maximum permissible residual gap has a width of 0.05 mm.

In one embodiment of the welding device, the two edges of the clamping device running directly along the welding line form a weld channel having a trapezoidal cross-section above the carrier table. Preferably the walls forming the weld channel and the contiguous underside of the clamping device are made of a material of particularly high thermal conductivity and dimensional stability. Such material must additionally present a high resistance to the unintentional input of the laser beam. In another embodiment, the walls of the weld channel and/or the purging duct are cooled, for which purpose, in one or more walls, ducts for circulating a liquid or gaseous coolant are provided.

In another embodiment of the welding device, the welding head is movable along a rail or is guided by means of a robot arm. Owing to the lack of linearity and parallelism of the two welding edges pressed against one another and fixed vertically, the welding line thus formed under horizontal pressure is not centred in the weld channel, but deviates from an ideal centre line on both sides. The welding head is therefore preferably mounted in such a way that it can be moved parallel and transversely with respect to the weld channel. In one embodiment, the welding head is connected to a control unit, by means of which the welding head moves sequentially in straight segments along the welding line. Preferably the welding head is connected to a control and regulation device and follows the path of the welding line within the deviation limits determined by means of technical devices, for example an optical detection system focusing the welding line, the ideal position of the laser head being controllable during the welding operation by means of such data.

For an easier positioning of the metal sheets on the carrier table, the latter is provided, in one embodiment of the welding device, with a multiplicity of conveying elements, so that the at least one metal sheet can be easily moved in any desired direction on the horizontal plane. The conveying elements preferably consist of a layer of individual balls or compressed-air outlets, by means of which a pressure cushion allowing a very easy conveyance of the metal sheets can be established under the at least one metal sheet.

The welding heads to be used for the welding device are preferably laser welding equipment or electron-beam welding equipment which is positioned on an advancing element which allows a welding speed of at least 4.5 m/min, preferably of 9 m/min. The pressing elements are preferably driven by means of one or more hydraulic or pneumatic cylinders.

Under another aspect, the invention is directed to a method for the linear butt welding of thin metal sheets without weld filler materials, making use of a device according to one of the above disclosed embodiments and simultaneously or sequentially comprising the following steps:

a) positioning of a first metal sheet on the carrier table, the welding edge lying centrally and in parallel above the purging duct within the tolerances,
b) vertical fixing of the first metal sheet on the carrier table by means of the first pressing element,
c) positioning of a second metal sheet on the carrier table, the welding edge lying above the purging duct and butting against the welding edge of the first metal sheet,
d) vertical prefixing of the second metal sheet on the carrier table by means of the second pressing element under a low pressure,
e) horizontal pressing of the second metal sheet against the first metal sheet by means of the at least one horizontal pressing element,
f) vertical fixing of the second metal sheet on the carrier table by means of the second pressing element,
g) complete or partial purging of the purging duct with protective gas,
h) laser welding with the simultaneous movement of the welding head under a protective-gas atmosphere,
i) opening of the clamping device and extraction of the metal sheet,
j) return to step a).

In step e), in which the horizontal pressing of the second metal sheet against the previously fixed first metal sheet is carried out, the applied compressive force is so high that the metal-sheet edge is deformed, resulting in a full-area gapless closure of the two adjoining metal-sheet edges.

Surprisingly, it was observed that, provided a sufficient horizontal compressive force is applied in the area near the butting edge, the relaxation in the fusion phase is sufficient to relieve the stresses along this edge. It was likewise possible to observe that the horizontal material compression along the butt-weld joint leads to an improved joint geometry. The fraction of evaporated material associated with any welding method without weld filler materials was again partially compensated by the expansion of the metal sheet in the direction of the fused joint.

In one embodiment, steps a) to j) are carried out sequentially in the indicated order; in different embodiments, steps a) and c) may be executed in reverse order or simultaneously with steps b) and d) following accordingly. Likewise, the first metal sheet may also be prefixed to the carrier table in step b), and in step f) both metal sheets may be fixed on the carrier table, the fixing of the two metal sheets preferably taking place simultaneously.

The vertical fixing of the metal sheet is in this case dependent on the horizontal forces and on the selected roughness of the pressing elements and of the base. The pressing force to be selected for the vertical prefixing of the metal sheets is likewise dependent on the surface of the pressing elements and of the base. It is essential that the possibility for horizontal movement of the metal sheet in the direction of the butting edge is not prevented completely. The horizontal fixing in step e) and the force required for achieving full-area contact of the two welding edges, along with controlled material deformation and material compression along the butting edge, are essentially dependent on the material and the thickness of the metal sheet and on the degree of non-linearity of the welding edges.

In the welding tests, a CO₂ laser with a power of 6 kW, a wavelength of 10.6 μm and a welding speed of 9 m/min was used. The metal-sheet materials used were nickel and titanium sheets. The edges of the titanium sheet to be welded had a length of 1358 mm. The weld channel had a width of 3 mm at the bottom.

In the tests, the transverse deviation of the weld joint was determined at individual measurement points and the CO₂ laser was controlled such that it was moved from measurement point to measurement point in segments along the welding line. The samples produced fulfilled all technical specifications and it was not possible to detect any waviness along the weld joint.

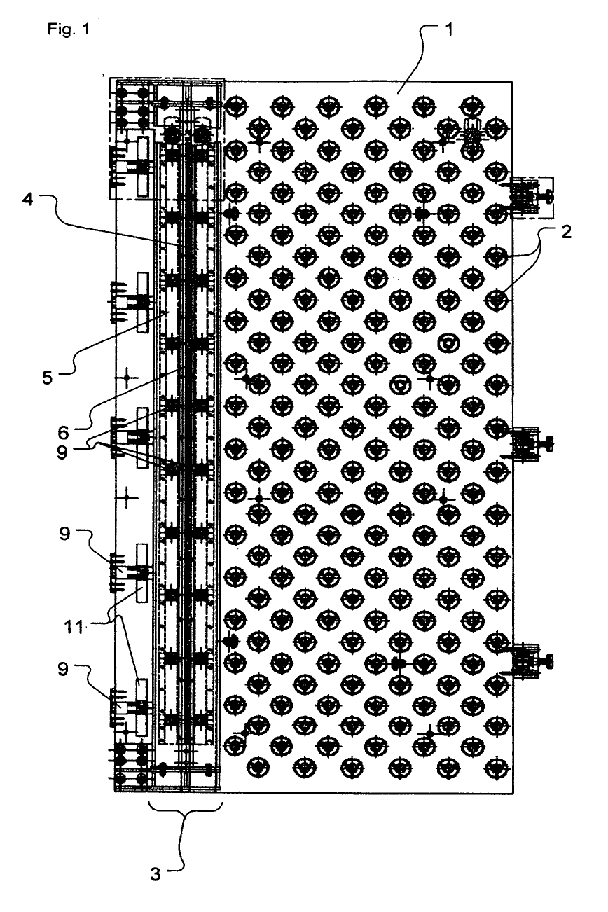

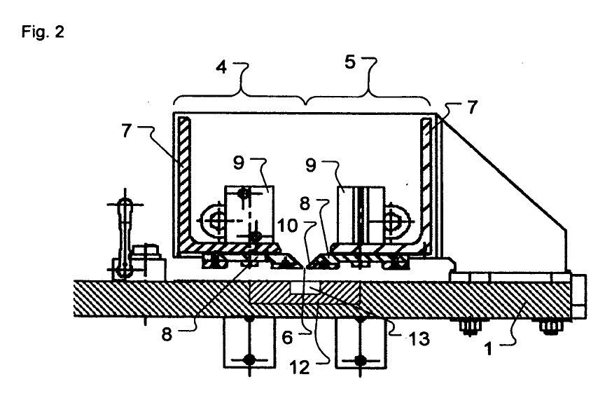

FIG. 1 to FIG. 2 show exemplary embodiments of the welding device. FIG. 1 is a top-view of the device. The carrier table 1 is shown without a metal sheet to be machined. A multiplicity of conveying elements 2 are shown in form of individual rollers, according to one embodiment. The clamping device 3, which is not suitable for being moved in the horizontal direction, extends over the entire width of the carrier table 1. The clamping device 3 comprises the two parallel pressing elements 4 and 5 for the vertical positioning and fixing of metal sheets.

The region between the two pressing elements 4 and 5 forms the weld channel 6. The clamping device 3 essentially divides the carrier table 1 into two parts. On the narrower part of the carrier table 1, along the carrier-table edge parallel to the weld channel 5, a multiplicity of horizontal pressing elements 11 are arranged, whereby a metal sheet introduced therein can be pushed in the direction of the weld channel 5 and against the other metal sheet, not shown, fixed thereto. The horizontal pressing elements 11 are driven by pneumatic cylinders 9.

FIG. 2 is a vertical section showing the details of the pressing elements 4 and 5 and of the weld channel 6. The pressing elements 4 and 5 comprise a beam-like, L shaped carrier 7 below which a horizontal fixing shoe 8 is arranged. Such fixing shoe 8 is raised or lowered by means of a multiplicity of pneumatic cylinders 9 arranged on the top side of the horizontal leg of the L shaped carrier 7.

The pneumatic cylinders 9 drive the two fixing shoes 8 independently of one another. The fixing shoes 8 are provided with a sole 10 along the weld channel 6 made of a metal alloy for optimal heat dissipation and dimensional stability. The facing front edges of the fixing shoes 8 and of the soles 10 are shaped so as to present a trapezoidal cross-section above the carrier table 1. In a weld channel 6 formed in this way, the protective gas flowing in is compressed in the direction of the duct bottom, and an excess of protective gas is always maintained.

At the bottom of the weld channel 6 and parallel thereto, the carrier table 1 has a strip 12 arranged therein provided with a groove 13 acting as purging duct for a protective-gas flow at the weld root. During operation it is provided that the metal sheets to be welded close the purging duct 13, so that only a relatively low volumetric flow of protective gas is required for an optimal protective-gas atmosphere.

Throughout the description and the claims of this specification the word “comprise” and variations of the word, such as “comprising” and “comprises” are not intended to exclude other additives, components, integers or steps.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention before the priority date of each claim of this application.

1. A device for the linear butt welding of thin metal sheets without weld filler materials, provided with a carrier table and at least one clamping device arranged above and parallel to the carrier-table surface suitable for positioning one or more metal sheets, the clamping device being capable of exerting pressure in the vertical direction on a metal sheet introduced thereunder, comprising
at least one welding head movable along the welding line,
at least two pressing elements operating independently of one another, arranged in parallel and spaced-apart along the welding line and movable independently of one another, at least one of said at least two pressing elements being suitable for applying two or more distinct pressure levels,
additional horizontal pressing elements arranged at least on the side of the carrier table of said at least one pressing element suitable for applying multiple distinct pressure level, by means of which at least one of the metal sheets to be welded can be pressed in the direction of the welding line and against the other metal sheet while undergoing a deformation.

2. The welding device of claim 1 further comprising a purging-gas duct running below the carrier table and parallel to the welding line.

3. The welding device of claim 1, wherein said at least two pressing elements are provided with soles for fixing or pre-fixing the metal sheets, wherein the edges of said pressing elements running along the welding line and said soles form a weld channel above the carrier table having a trapezoidal cross-section.

4. The welding device of claim 3 wherein said trapezoidal cross section narrows in the vertical direction towards the carrier table.

5. The welding device of claim 3 wherein the walls of said weld channel and the contiguous underside of the at least one clamping device are made of a material of high thermal conductivity and dimensional stability.

6. The welding device claim 2, wherein the walls of said purging gas duct are made of a material of high thermal conductivity and dimensional stability.

7. The welding device of claim 1 wherein said at least one welding head is movable along a rail or is guided by a robot arm.

8. The welding device of claim 1 wherein the carrier table is further provided with a multiplicity of conveying elements allowing the movement of the metal sheets in any direction on the horizontal plane.

9. The welding device of claim 8 wherein said conveying elements consist of a layer of individual balls or rollers or compressed-air outlets.

10. The welding device of claim 1 wherein at least one of said pressing elements is driven by at least one hydraulic or pneumatic cylinder.

11. The welding device of claim 1 wherein at least one welding head is a laser-welding or electron-beam welding equipment.

12. The welding device of claim 1 wherein at least one welding head is connected to at least one means for moving it parallel and transversely with respect to the weld channel.

13. The welding device of claim 12 wherein said means for moving said welding device is a drive element connected to a control and regulation device.

14. The welding device of claim 13 wherein said control and regulation device is connected to an optical sensor for determining the position of the welding line.

15. A method for the linear butt welding of thin metal sheets comprising sequentially or simultaneously executing the following steps in a welding device of claim 2:
a) positioning of a first metal sheet on the carrier table, the welding edge lying centrally and in parallel above said purging duct,
b) vertical fixing of the first metal sheet on the carrier table by means of the first of said at least two pressing elements,
c) positioning of a second metal sheet on the carrier table, the welding edge lying above said purging duct and butting against the welding edge of said first metal sheet,
d) vertical pre-fixing of the second metal sheet on the carrier table by means of the second of said at least two pressing elements under a low pressure,
e) horizontal pressing of said second metal sheet against said first metal sheet by means of said at least one horizontal pressing element,
f) vertical fixing of said second metal sheet on the carrier table by means of the second of said at least two pressing elements,
g) complete or partial purging of said purging duct with protective gas,
h) welding while moving said at least one welding head under a protective-gas atmosphere,
i) opening of the clamping device and extraction of the resulting metal sheet, and
j) optional return to step a).

16. The method of claim 15 wherein said steps are executed sequentially as listed.

17. The method of claim 15 wherein steps a) and c) are executed in reverse order than listed or simultaneously with steps b) and d) following accordingly.

18. The method of claim 15 wherein both of said metal sheets are fixed on the carrier table in step f).

19. The method of claim 18 wherein said fixing of both metal sheets on the carrier table is performed simultaneously.

20. The method of claim 15 wherein said horizontal pressing in step e) leaves a maximum residual gap of 0.05 mm between said first and second metal sheet.

21. The method of claim 15 wherein after step g) the transverse deviation of the actual welding line from the ideal line is determined as discrete values, subsequently sequentially moving said welding head in straight segments along the welding line by means of a control unit.

22. The method of claim 21 wherein said actual welding line is detected by means of an optical sensor, such data being transferred to a control unit adjusting the movement of said welding head.
